(19) United States
(12) Patent Application Publication
(10) Pub. No.: US 2009/0099937 A1
(43) Pub. Date: Apr. 16, 2009

(54) Product ordering apparatus

(75) Inventor: Takahisa Onishi, Kyoto-Shi (JP)

Correspondence Address: EDWARDS ANGELL PALMER & DODGE LLP, P.O. BOX 55874, BOSTON, MA, 02205, US

(73) Assignee: Sharp Kabushiki Kaisha, Osaka (JP)

(21) Appl. No.: 12/287,114

(22) Filed: Oct. 6, 2008

(30) Foreign Application Priority Data
Oct. 11, 2007 (JP) 2007-265671

(51) Int. Cl. G06Q 30/00; G06Q 20/00

(52) U.S. Cl. 705/24; 705/26; 705/27

(57) ABSTRACT

In one embodiment of a product ordering apparatus, information of a service entrusted from a service-providing company is selected from an operating unit, and when product information in that service is selected from the operating unit, the service-providing company is designated, the format of an order form is determined by designating the service-providing company, personal information and store information are automatically input along with product information to data of the determined order form, and after a payment procedure in a settlement device, order form data in which the information has been automatically entered is automatically sent by facsimile to a device of the service-providing company due to a request from the settlement device, and after sending the facsimile, when outputting a communications results report, the contents of the order form are printed on paper as a copy together with the communications results report.

### BACKGROUND OF THE INVENTION

This application claims priority under 35 U.S.C. §119(a) on Japanese Patent Application No. 2007-265671 filed in Japan on Oct. 11, 2007, the entire contents of which are herein incorporated by reference.

The present invention relates to a product ordering apparatus that orders a product desired by a customer.

In the conventional mode of service when a customer purchases a product, for example, a customer orders a desired product using a device having a facsimile function (for example, a facsimile apparatus or a digital multifunction printer).

For example, in the conventional mode of service, after the customer enters necessary items by hand in a product order form that has been widely distributed to customers, this is sent by fax to a service-providing company to order a product.

However, in the conventional mode of service, there is much troublesome work, such as distribution of order forms, entering of information in an order form by hand, management of submitted order forms, and management of communications records of fax transmission when ordering products, so ordering mistakes easily occur. Thus the conventional mode of service is inefficient.

In the related technical field, there is JP 2003-233725A as a reference document. This reference document discloses personal authentication from a membership card of a user.

### SUMMARY OF THE INVENTION

It is an object of the invention to provide a product ordering apparatus that can reduce troublesome work performed in order to order a product, such as distribution of order forms and entering information in order forms, and thus makes it possible to accurately and efficiently order a product.

In order to address the above problems, the invention is directed to a product ordering apparatus having an operating unit capable of a human input operation and capable of displaying information, the product ordering apparatus being connected to a device of a service-providing company via a communications line, and connected to a settlement device for performing a payment procedure, and the product ordering apparatus being installed in a store that the service-providing company has entrusted with a service, the product ordering apparatus comprising: a product selecting means that makes it possible to select and input information of the service entrusted from the service-providing company with the operating unit, and makes it possible to select and input product information in the selected service with the operating unit; a form format determining means that, by product information being selected with the product selecting means, designates a corresponding service-providing company, and by designating the service-providing company, determines the format of an order form; an information automatic input means that automatically inputs personal information of a customer that has been registered in advance and information of a store that has been registered in advance, along with product information that has been selected with the product selecting means, to data of the order form that has been determined with the form format determining means; an order form automatic facsimile sending means that, after a payment procedure has been performed in the settlement device, due to a request from the settlement device, automatically sends by facsimile via the communications line, to the device of the service-providing company designated by the form format determining means, order form data in which personal information and store information as well as product information have been automatically input with the information automatic input means; and a copy collective printing means that, after facsimile sending by the order form automatic facsimile sending means, when outputting a communications results report, prints together on paper the contents of the order form as a copy with the communications results report.

In the product ordering apparatus according to the invention, from among information of services entrusted from the service-providing company, desired service information is selected and input with the operating unit, and desired product information is selected and input with the operating unit from among product information in the selected service. At this time, by the product information being selected, the corresponding service-providing company is designated, the format of an order form is determined by designating the service-providing company, and personal information of a customer that has been registered in advance and store information that has been registered in advance are automatically input along with the selected product information to data of the determined order form. After a payment procedure in a settlement device has been performed, the order form data in which the personal information, the store information, and the product information have been automatically entered is automatically sent by facsimile via the communications line to a device of the designated service-providing company due to a request from the settlement device. After sending the facsimile, when outputting a communications results report, the contents of the order form are printed on paper as a copy together with the communications results report.

In this way, according to the product ordering apparatus of the invention, by selecting product information, it is possible to automatically create an order form in a format that corresponds to the service-providing company to which the order is issued, and it is possible to automatically send the order form to the service-providing company to which the order is issued, so delivery can be confirmed from the communications results. Accordingly, it is possible to reduce the amount of troublesome work to order a product such as distributing order forms and entering information in an order form, and thus it is possible to accurately and effectively order a product.

Specific exemplary embodiments of the product ordering apparatus of the invention include:

(a) an embodiment in which the product selecting means displays a list with images such that service information of the service-providing company and product information thereof can be selected and input in the operating unit, and the list with images has a search function;

(b) an embodiment in which the product ordering apparatus is connected via a computer network to the settlement device, and can be connected via the computer network to a management server for managing information of the service-providing company as well as service information of the service-providing company and product information thereof, and furthermore, the product ordering apparatus is capable of reading a storage medium on which the information of the service-providing company as well as service information of the service-providing company and product information thereof have been stored in advance; and the form format determining means is provided with a first determining means that automatically determines the format of the order form by designating a corresponding service-providing company via the computer network from the information of the service-providing company managed with the management server based on the product information selected with the product selecting means, and a second determining means that automatically determines the format of the order form by designating a corresponding service-providing company from the information of the service-providing company stored on the storage medium based on the product information selected with the product selecting means;

(c) an embodiment in which the product ordering apparatus is connected via a computer network to the settlement device, and can be connected via the computer network to an authentication server for authenticating personal information of a customer, and furthermore, the product ordering apparatus is capable of reading an IC card on which personal information of a customer has been stored in advance; and the information automatic input means automatically inputs personal information of a customer by selecting either to read personal information that has been stored on the IC card from the IC card, or to request personal information of the authentication server from the authentication server via the computer network;

(d) an embodiment in which the order form data that has been automatically input with the information automatic input means is saved in a storage unit; and the order form automatic facsimile sending means, after adding an electronic receipt stamp having payment information such as a store name and payment date, automatically sends a facsimile of the order form data stored in the storage unit after the payment procedure is completed in the settlement device, via the communications line to the device of the service-providing company designated with the form format determining means;

(e) an embodiment in which the copy collective printing means has a security function to display a message that confirms whether or not there was a printing error after printing, such that a confirmation input operation is possible in the operating unit, and delete data used for the printing after the confirmation input operation has been performed;

(f) an embodiment in which the product ordering apparatus comprises a discharge unit that discharges paper on which printing has been performed with the copy collective printing means, in which the copy collective printing means has a function to detect whether or not paper discharged to the discharge unit has been removed from the discharge unit, and until removal of the paper from the discharge unit has been detected, make it impossible to perform the next job, thus preventing forgetting to remove the paper from the discharge unit;

(g) an embodiment in which after personal information, store information, and product information have been automatically input to an order form by the information automatic input means, a response to information of other services and product-specific information can be input from the operating unit, and it is possible to print a format in which personal information, store information, and product information, and information of other services and product-specific information, are written, and furthermore, it is possible to select between inputting the response from the operating unit, or printing the format; and

(h) an embodiment in which at least two of above embodiments (a) to (g) are combined.

With the invention configured in this manner, it is possible to provide a product ordering apparatus that can reduce the amount of troublesome work to order a product such as distributing order forms and entering information in an order form, and thus makes it possible to accurately and effectively order a product.

### BRIEF DESCRIPTION OF THE DRAWINGS

FIG. 1 shows an overview of a product ordering system provided with a digital multifunction printer that is one embodiment of a product ordering apparatus according to the invention.

FIG. 2 is a system block diagram that shows the overall structure of the digital multifunction printer according to this embodiment.

FIG. 3 is a basic flowchart that shows an example of an operation flow when ordering a product with the digital multifunction printer according to this embodiment.

FIG. 4 shows an example of the format of an order form.

FIG. 5 shows another example of the format of an order form.

FIG. 6 shows still another example of the format of an order form.

### DESCRIPTION OF THE PREFERRED EMBODIMENTS

Hereinafter, preferred embodiments of the present invention will be described in detail with reference to the accompanying drawings. Note that the embodiments below are specific examples of the invention, and do not limit the technical scope of the invention.

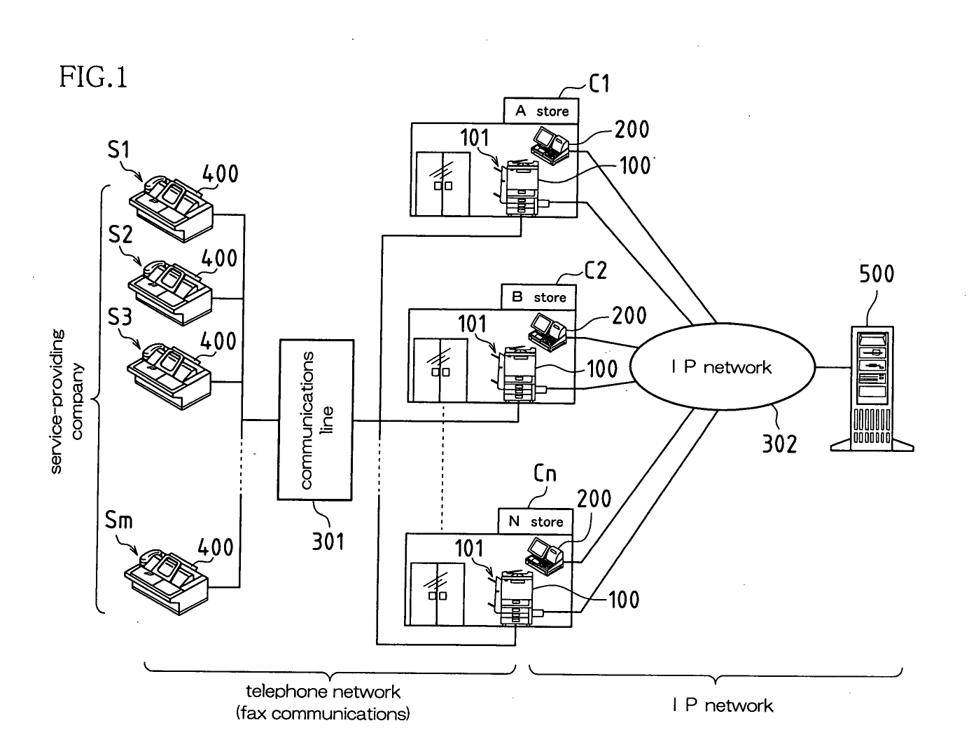

FIG. 1 shows an overview of a product ordering system provided with a digital multifunction printer 100 that is one embodiment of a product ordering apparatus according to the invention.

The digital multifunction printer (MFP) 100 shown in FIG. 1, here, has a plurality of functions, including at least a facsimile (fax) function from among a copy function, a printer function, a scanner function, and a facsimile function. In this embodiment, a digital multifunction printer is used as a product ordering apparatus, but a facsimile apparatus or a computer system having a facsimile function may also be used.

The digital multifunction printer 100 is used installed in stores (for example, such as convenience stores) C1, . . . , Cn (where n is an integer of 1 or more) that are entrusted with a service from one or a plurality of service-providing companies S1, . . . , Sm (where m is an integer of 1 or more) that provide a service such as a gift service or a New Year's card printing service, and receive requests for that service.

The digital multifunction printer 100 is connected to a device 400 of the service-providing companies S1, . . . , Sm via a communications line 301, and is also connected to a settlement device 200 for performing a payment procedure. The device of the service-providing company may be a facsimile apparatus or a computer system having a facsimile function, for example. The settlement device may be a POS (Point Of Sale) system terminal apparatus (a POS register), for example. A telephone network of a telecommunications carrier is a representative example of the communications line.

Specifically, the digital multifunction printer 100 is capable of exchanging information with the device 400 of each of the service-providing companies S1, . . . , Sm via the communications line 301 by facsimile communications. Also, the settlement device 200 is provided along with the digital multifunction printer 100 in the stores C1, . . . , Cn. The digital multifunction printer 100 and the settlement device 200, here, are connected to each other via a computer network 302. An IP network constructed by connecting networks to each other using an IP (Internet Protocol) is a representative example of the computer network.

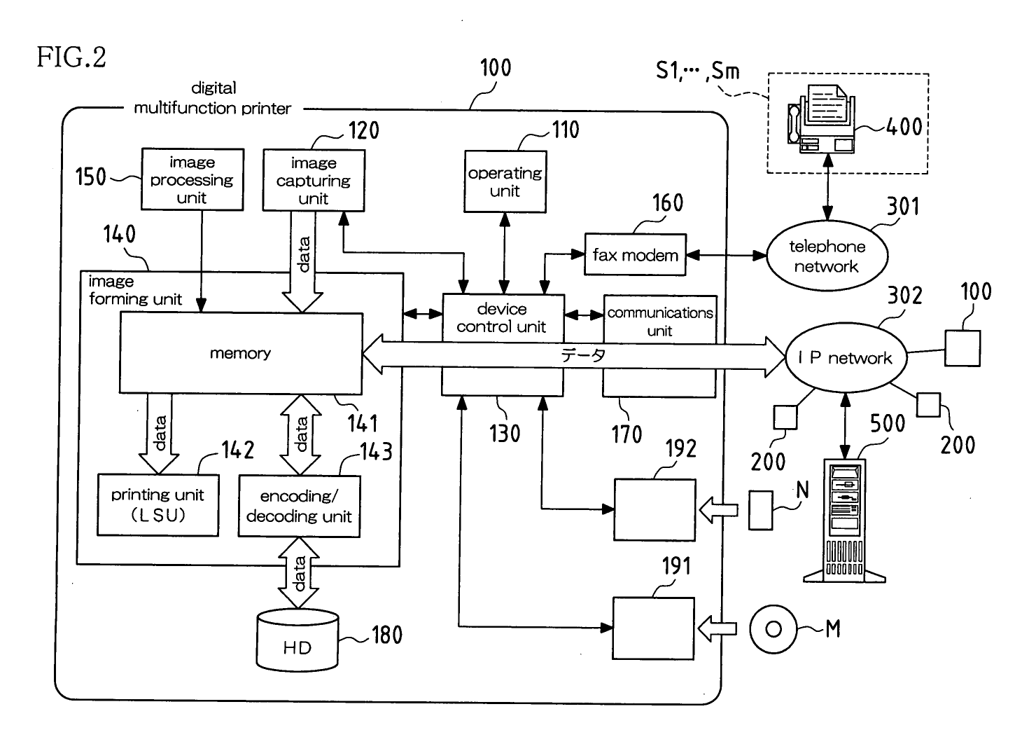

FIG. 2 is a system block diagram that shows the overall structure of the digital multifunction printer 100 according to this embodiment.

The digital multifunction printer 100 shown in FIG. 2 is provided with an operating unit 110 that receives operation information from a customer input operation, an image capturing unit 120 that captures an original as image data, a device control unit 130 that performs overall control of the digital multifunction printer 100, an image forming unit 140 that performs print processing based on the image data, an image processing unit 150 that performs data processing of the image data, and a facsimile modem 160 that is connected for communications to the communications line 301. Here, the digital multifunction printer 100 is also provided with a communications unit 170 that is connected for communications to the computer network 302.

More specifically, the operating unit 110, as shown in FIG. 2, is connected to an input system and an output system of the device control unit 130, and is a display/operating unit that is capable of human input operations and capable of displaying information. The operating unit 110 can receive operating information from the customer and send this information to the device control unit 130, and can perform screen display of display data from the device control unit 130. Examples of the operating unit 110 include an operating panel such as a liquid crystal display apparatus (LCD touch panel apparatus) provided with a touch panel apparatus, an operating panel provided with key operating members and a display apparatus, and the like.

The device control unit 130 controls operation of each function provided by the digital multifunction printer 100, such as a copy function, a scanner function, a facsimile function, and a printer function. The device control unit 130 also manages operating information from the operating unit 110, and is configured with a CPU (Central Processing Unit), a ROM (Read Only Memory), a RAM (Random Access Memory) and the like. Based on the operating information from the operating unit 110, the device control unit 130 causes operation of each function and manages the operating status of each function, and also, on a display screen in the operating unit 110, displays service information and product information of the service-providing companies, described below.

The image capturing unit 120 captures an image of an original as image data, and inputs the captured image data to a memory (for example, a RAM area) 141 of the image forming unit 140.

The image forming unit 140 is an output means that processes image data and prints the image data on paper. Specifically, the image forming unit 140 is provided with the memory 141 that stores image data, and a print unit 142 that is configured from an LSU (Laser Scanning Unit) or the like that writes an electrostatic latent image based on image data to an image carrier (for example, a photosensitive body) with laser light. The image forming unit 140 temporarily stores image data from the image capturing unit 120 to a storage unit 180 such as a hard disk (HD) provided within the digital multifunction printer 100 via the memory 141, again transfers this image data stored in the storage unit 180 to the print unit 142 via the memory 141, and here outputs the image data by printing.

The image processing unit 150 performs various image processing on image data. The facsimile modem 160 sends/receives facsimile data to/from the device 400 of the service-providing companies S1, . . . , Sm via the communications line 301. Thus, the digital multifunction printer 100 is capable of facsimile data information communications with the device 400 of each of the service-providing companies S1, . . . , Sm via the communications line 301. The communications unit 170 performs data communications via the computer network 302.

More specifically, the device control unit 130 is capable of performing control related to the product ordering system according to operating information from the operating unit 110. The image forming unit 140, here, has an encoding/decoding unit 143. The encoding/decoding unit 143 is capable of extracting image data stored in the storage unit 180, and processing and editing information stored in the storage unit 180 based on the operating information received from the device control unit 130. In this digital multifunction printer 100, with a control performed by the device control unit 130, image data of an original that has been captured with the image capturing unit 120 is stored in the memory 141. Print processing of the data stored in the memory 141 is performed by the print unit 142, or the data stored in the memory 141 is sent by the facsimile modem 160 as a facsimile via the communications line 301.

The device control unit 130 is provided with a product selecting means P1, a form format determining means P2, an information automatic input means P3, an order form automatic facsimile sending means P4, and a copy collective printing means P5.

With the product selecting means P1, it is possible for a customer to select and input information related to a service entrusted from one or a plurality of the service-providing companies S1, . . . , Sm using the operating unit 110, and it is possible for a customer to use the operating unit 110 to select and input product information within the service selected by the customer. Thus, it is possible to determine a product for the product information selected by the customer. Here, service information and product information thereof of the service-providing companies S1, . . . , Sm may be provided by reading, from a storage means (for example, the storage unit 180) within the digital multifunction printer 100, service information and product information thereof that has been saved in advance in that storage means, or, when it is possible for the digital multifunction printer 100 to connect to a management server 500 described below via the computer network 302, that information may be provided from the management server 500 via the computer network 302, and when the digital multifunction printer 100 is made capable of reading a recording medium M described below, that information may be read from the recording medium M.

Due to product information being selected with the product selecting means P1, the form format determining means P2 designates a corresponding service-providing company from the service-providing companies S1, . . . , Sm, and automatically determines the format of an order form by designating the service-providing company.

The information automatic input means P3 automatically inputs personal information of a customer that has been registered in advance and store information that has been registered in advance, along with product information that has been selected with the product selecting means P1, to data of the order form determined by the form format determining means P2.

The order form automatic facsimile sending means P4, after a payment procedure has been performed in the settlement device 200, due to a request from the settlement device 200, automatically sends by facsimile via the communications line 301, to the device 400 of the service-providing company designated by the form format determining means P2, order form data in which personal information and store information as well as product information have been automatically input with the information automatic input means P3.

The copy collective printing means P5, after facsimile sending by the order form automatic facsimile sending means P4, when outputting a communications results report, prints the contents of the order form as a copy together with the communications results report on paper.

In the digital multifunction printer 100 described above, when from among information of services entrusted from one or a plurality of service-providing companies S1, . . . , Sm, desired service information is selected and input by a customer with the operating unit 110, and desired product information is selected and input by the customer with the operating unit 110 from the product information within the service selected by the customer, a product for the product information selected by the customer is determined. At this time, due to product information being selected, the corresponding service-providing company is designated, and by designating this service-providing company, the order form format is determined, and personal information of a customer that has been registered in advance and store information that has been registered in advance, along with the product information that has been selected, is automatically input to the data of the determined order form. Afterward, the payment procedure with the settlement device 200 is performed.

After the payment procedure with the settlement device 200 has been performed, due to a request from the settlement device 200, the order form data in which the personal information and the store information as well as the product information have been automatically input is automatically sent to the designated service-providing company by facsimile via the communications line 301. After sending the facsimile of the order form, a copy of the contents of the order form is printed on paper together with the communications results report that is output.

In this way, with the digital multifunction printer 100 according to this embodiment, by selecting product information, it is possible to automatically create an order form in a format that corresponds to the service-providing company that is the order recipient, and it is also possible to automatically send the order form to the service-providing company that is the order recipient, so delivery can be confirmed from communications results. Therefore, troublesome work for ordering a product, such as distribution of order forms, hand-written entry of information in order forms, management of submitted order forms, management of communications records of facsimile sending performed when placing an order, and the like can be made easy, without ordering mistakes, and thus it is possible to accurately and effectively order products.

In this embodiment, the product selecting means P1 is capable of displaying a list with images such that service information of the service-providing companies S1, . . . , Sm and product information thereof can be selected and input by the customer in the operating unit 110. This list with images has a search function. By configuring the list in this way, it is possible to simply and easily search the service information and product information displayed in the operating unit 110.

Also, the digital multifunction printer 100 according to this embodiment can be connected via the computer network 302 to the management server 500 for managing information of the service-providing companies S1, . . . , Sm as well as service information of the service-providing companies S1, . . . , Sm and product information thereof. Furthermore, the digital multifunction printer 100 is capable of reading a storage medium M on which information of the service-providing companies S1, . . . , Sm as well as service information of the service-providing companies S1, . . . , Sm and product information thereof has been stored in advance. That is, this digital multifunction printer 100 is further provided with an information reading apparatus 191 for reading information of a storage medium M.

The information reading apparatus 191 is connected to the device control unit 130, and under instruction from the device control unit 130, is capable of reading information of the storage medium M and sending the read information to the device control unit 130. Also, the form format determining means P2 is provided with a first determining means P21 and a second determining means P22. The first determining means P21 automatically determines the format of the order form by designating a corresponding service-providing company via the computer network 302 from the information of the service-providing companies S1, . . . , Sm managed with the management server 500 based on the product information selected with the product selecting means P1. The second determining means P22 automatically determines the format of the order form by designating a corresponding service-providing company from the information of the service-providing companies stored on the storage medium M based on the product information selected with the product selecting means P1. By adopting such a configuration, it is possible to easily obtain information of the service-providing company and product information, and to that extent it is possible to reduce the work of ordering products.

Also, the digital multifunction printer 100 according to this embodiment is capable of reading an IC card N on which personal information of a customer has been stored in advance. That is, this digital multifunction printer 100 is further provided with a card reading apparatus 192 for reading information of the IC card N. The card reading apparatus 192 is connected to the device control unit 130, and under instruction from the device control unit 130, is capable of reading information of the IC card N and sending the read information to the device control unit 130.

Also, the digital multifunction printer 100 is capable of performing customer login, and can be connected via the computer network 302 to an authentication server 500 for authenticating personal information of customers. Here, the same server 500 is used for the authentication server and the aforementioned management server, but individual servers may also be used. The information automatic input means P3, by selecting either to read personal information recorded on the IC card N from the IC card N, or to obtain personal information of the authentication server 500 from the authentication server 500 via the computer network 302, automatically inputs personal information of a customer. By adopting such a configuration, it is possible to easily obtain personal information, and to that extent it is possible to reduce the work of ordering products.

Also, in the digital multifunction printer 100 according to this embodiment, the order form data that has been automatically input with the information automatic input means P3 is saved in the storage unit 180, and the order form automatic facsimile sending means P4 reads the order form data stored in the storage unit 180 from the storage unit 180 after the payment procedure with the settlement device 200 is completed, adds an electronic receipt stamp having payment information such as a store name and payment date, and then automatically sends the data by facsimile via the communications line 301 to the device 400 of the service-providing company designated with the form format determining means P2. By adopting such a configuration, it is possible to omit the work of manually applying a receipt stamp to the order form, and to that extent it is possible to reduce the work of ordering products.

Also, in this embodiment, the copy collective printing means P5 has a security function to display a message that confirms whether or not there was a printing error after printing such that a confirmation input operation is possible in the operating unit 110, and delete data used for printing after the confirmation input operation has been performed. By adopting such a configuration, it is possible to effectively prevent printing errors, and also it is possible to protect personal information and the like of customers, thus insuring security.

Also, the digital multifunction printer 100 according to this embodiment is provided with a discharge unit (here, a discharge tray) 101 that discharges paper on which printing has been performed with the copy collective printing means P5. Furthermore, the copy collective printing means P5 has a function to detect whether or not paper discharged to the discharge unit 101 has been removed from the discharge unit 101, and make it impossible to perform the next job until removal of the paper from the discharge unit 101 has been detected, thus preventing a user from forgetting to remove the paper from the discharge unit 101. More specifically, the copy collective printing means P5 is provided with a paper detecting means P51 that detects whether or not paper discharged to the discharge unit 101 has been removed from the discharge unit 101, and a prohibiting means P52 that makes it impossible to perform the next job until removal of the paper from the discharge unit 101 has been detected with the paper detecting means P51. By adopting such a configuration, it is possible to effectively prevent a user from forgetting to remove paper on which printing has been performed from the discharge unit 101. Note that the paper detecting means P51 and the prohibiting means P52 can have a conventionally known configuration, and so a detailed description of their configuration is omitted here.

Also, in this embodiment, in the device control unit 130, after personal information, store information, and product information have been automatically input to an order form by the information automatic input means P3, a response (answer) to information of other services and product-specific information can be input by a customer from the operating unit 110, and the device control unit 130 is capable of printing a format in which personal information, store information, and product information, and information of other services and product-specific information, are written. Further, the device control unit 130 is capable of switching between an input mode in which the response is input from the operating unit 110, and a printing mode in which the format is printed. In the input mode, for example, data of an order form in which personal information, store information, and product information, and information of other services and product-specific information as well as a response to those pieces of information, has been input, may be printed on paper. In this case, a customer may perform settlement with the settlement device 200 using printed order form paper.

In the digital multifunction printer 100 provided with this configuration, due to the input mode being selected, the customer can easily input responses to information of other services and product-specific information from the operating unit 110. This input mode is preferably selected when personal information and store information has been recorded in advance. The printing mode is preferably selected when personal information and store information has not been recorded in advance. When the printing mode is selected, the customer can enter by handwriting responses (answers) to personal information and store information, and information of other services and product-specific information. A customer may perform settlement with the settlement device 200 using order form paper in which responses to personal information and store information, and information of other services and product-specific information, have been entered by handwriting.

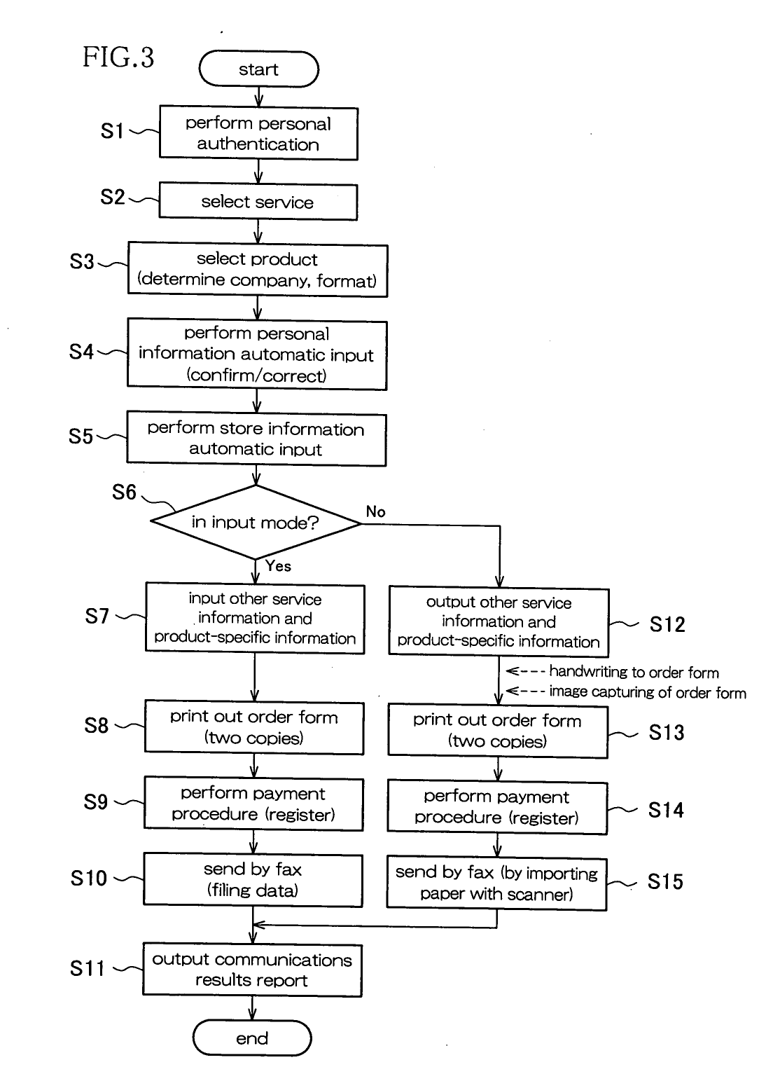

Next is a description of a product ordering processing flow with the digital multifunction printer 100. FIG. 3 is a basic flowchart that shows an example of an operation flow when ordering a product with the digital multifunction printer 100 according to this embodiment. In the below processing flow description, the discharge unit 101 is a discharge tray, the operating unit 110 is an operating panel, and the storage unit 180 is an HD apparatus. Also in this description the settlement device 200 is a POS register, the communications line 301 is a telephone network, the computer network 302 is an IP network, and the device 400 of the service-providing company is a facsimile apparatus.

In the processing flow shown in FIG. 3, first, personal authentication of the customer is performed using an IC card N or identification information (typically an ID and password) (Step S1).

More specifically, when personal authentication of the customer is performed using an IC card N, personal information is read with the card reading apparatus 192 from an IC card N on which personal information has been registered. When personal authentication of the customer is performed using authentication information, by logging in from the operating unit 110 with the authentication information, the authentication information is sent to the authentication server 500 via the IP network 302, and in the authentication server 500, the personal information that corresponds to the authentication information is extracted, and this personal information is sent via the IP network 302 to the digital multifunction printer 100 where the authentication information has been input.

Next, after personal information of the customer has been specified by the personal authentication processing in Step Si, a selection screen of various services is displayed in the display screen of the operating panel 110 (Step S2). At this time, in a case where the digital multifunction printer 100 is connected to the management server 500 via the IP network 302, information of the services of the service-providing companies S1, . . . , Sm and product information thereof can be provided from the management server 500 via the IP network 302. Also, when using a storage medium M, regardless of whether or not the digital multifunction printer 100 is connected to the management server 500, it is possible to provide that information by extracting the information from the storage medium M with the information reading apparatus 191.

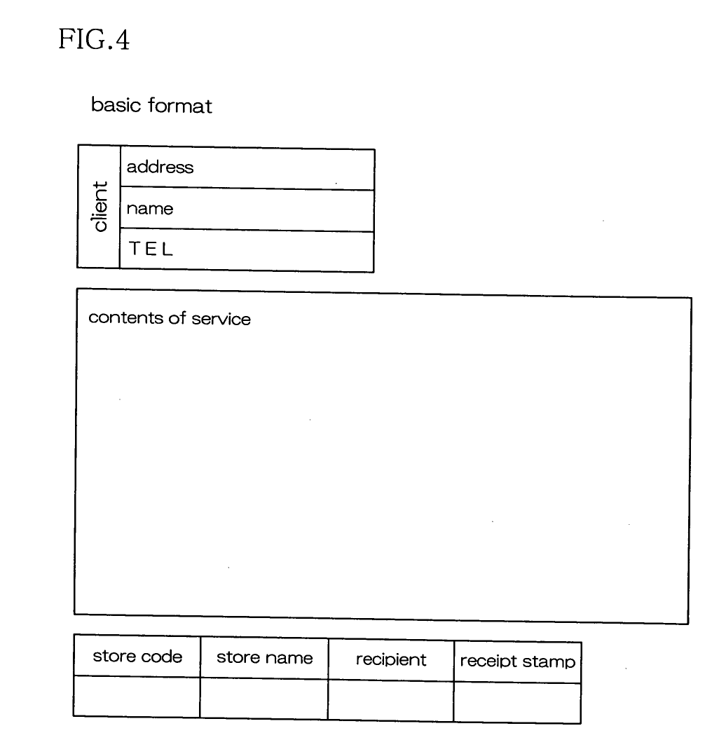

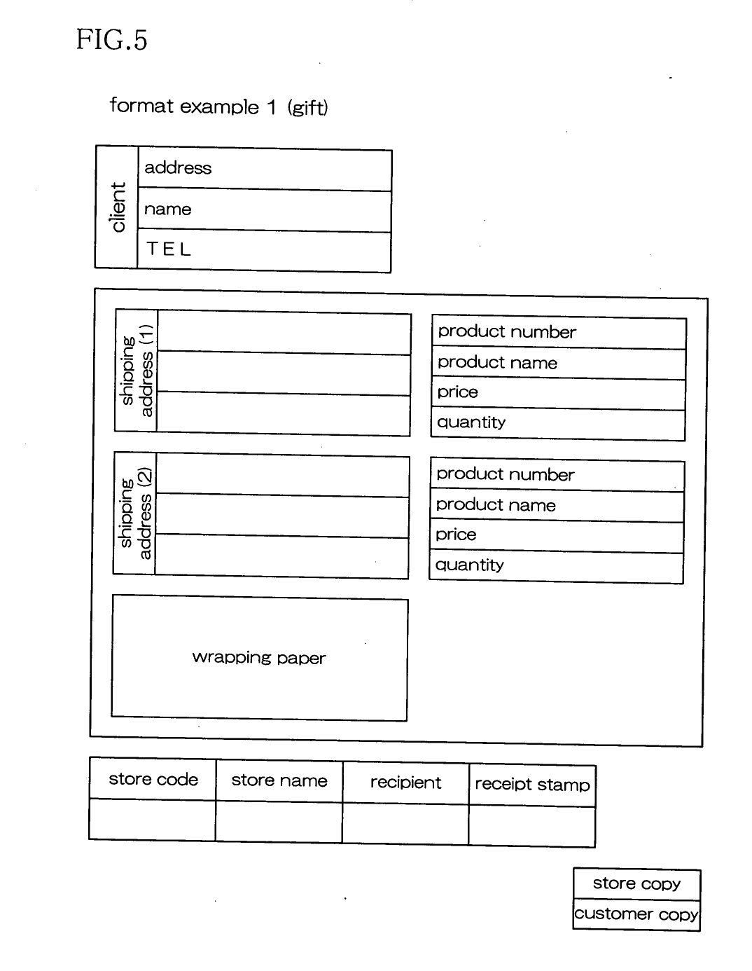

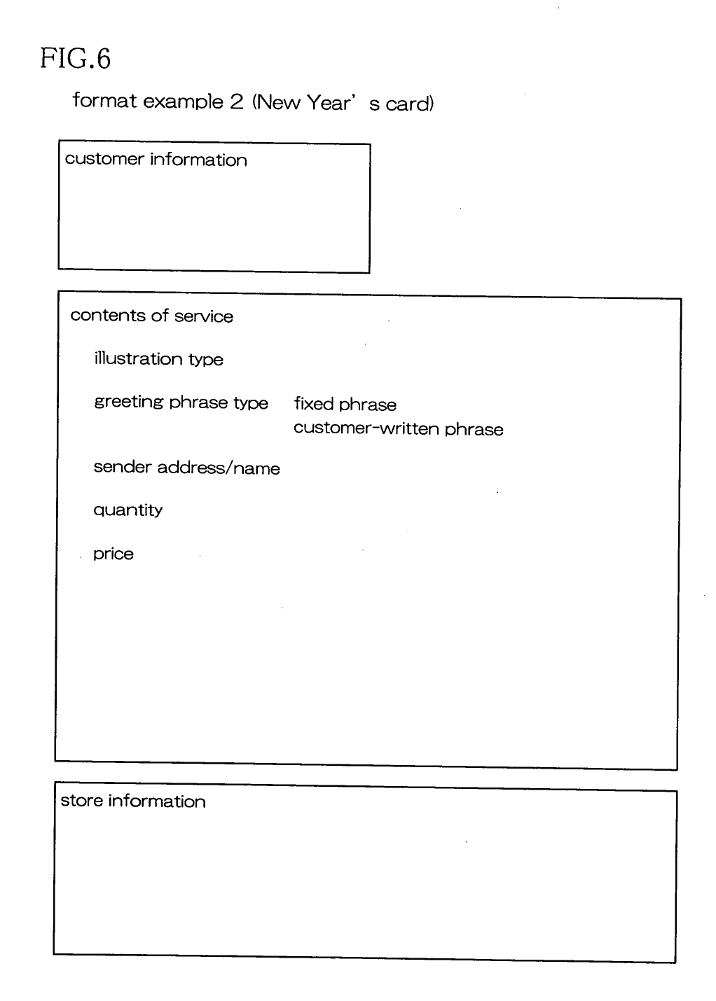

When a customer selects desired service information from among the information of various services displayed on the display screen of the operating panel 110, information of products (here, a list of product information with images) provided by the selected service is displayed. Next, the customer selects desired product information from among the displayed product information. At this stage, the service-providing company is designated, and an order form format is determined according to the information of the designated company, and information of the selected service and product information (Step S3). FIGS. 4 to 6 show examples of order form formats.

Specifically, in a case where the digital multifunction printer 100 is connected to the management server 500 via the IP network 302, by designating the service-providing company from information obtained via the IP network 302 from the management server 500 based on the selected product information, it is possible to automatically select an order form format such as those shown in FIGS. 4 to 6. Also, when using a storage medium M, regardless of whether or not the digital multifunction printer 100 is connected to the management server 500, by designating the service-providing company from the information obtained from the storage medium M with the information reading apparatus 191 based on the selected product information, it is possible to automatically select an order form format such as those shown in FIGS. 4 to 6.

When a format is determined in this way, the personal information of the customer is automatically input along with the product information to the data of that format (Step S4). After the personal information has been automatically input, it is possible to confirm and correct the personal information using the operating panel 110. Here, personal information means information that can designate a person, such as a customer's address, name, telephone number, and the like. This personal information can be acquired at the time of personal authentication in Step S1 by reading from an IC card N on which the personal information has been registered in advance, or by requesting the data from the management server 500 connected via the IP network 302.

After completing automatic input of personal information, store information is automatically input (Step S5). Here, store information means information that can designate a store, such as a store name, a store code, or the like. This store information may be requested via the IP network 302 from the management server 500, where store information has been saved in advance, or store information may be saved in advance on a storage means (for example, the HD apparatus 180) within the digital multifunction printer 100, and read out from the storage means.

After automatic input of personal information and store information is completed, the input mode, in which responses corresponding to information of other services and product-specific information are input from the operating panel 110, is selected, or the printing mode, in which a format is printed in which is written personal information, store information, and product information, and information of other services and product-specific information, is selected (Step S6). Here, examples of the information of other services and product-specific information include, in a case where the content of service is a gift product sales service, a shipping address and name, whether or not a gift is wrapped, the type of wrapping, and the like. In a case where the content of service is a New Year's card sales service, examples of the information of other services and product-specific information include a type of illustration, type of greeting phrase, address and name of the sender, and the like.

When the input mode is selected (Yes in Step S6), the display screen of the operating panel 110 displays an input screen of information of other services and product-specific information (Step S7). That is, an input form for each of various formats is displayed on the operating panel 110. Thus, the customer can perform input according to a displayed input form.

After input to the input form by the customer is completed, the order form is output by printing, along with a copy of the order form for the customer (Step S8). This order form data is filed and saved in the HD apparatus 180 of the digital multifunction printer 100. The customer brings the order form to the POS register 200. Then, the payment procedure is carried out at the POS register 200 (Step S9).

After the payment procedure is completed, the POS register 200 requests that the digital multifunction printer 100 send a fax. Thus, the digital multifunction printer 100 automatically sends a facsimile of the order form filed and saved in the HD apparatus 180 via the telephone network 301 to the facsimile apparatus 400 of the corresponding service-providing company (Step S10).

Here, after the payment procedure in the POS register 200 is completed, the data of the order form saved in the HD apparatus 180, after adding an electronic receipt stamp having payment information such as a store name and payment date to that data, is automatically sent by fax via the telephone network 301 to the facsimile apparatus 400 of the corresponding service-providing company.

After fax transmission to the service-providing company is completed, a communications results report is output (Step S11), and processing is ended. Order form data is also written in this communications results report. Here, a message that confirms whether or not there was a printing error is displayed after printing, such that a confirmation input operation is possible in the operating panel 110, and data used for printing is deleted after the confirmation input operation has been performed. Also, whether or not the paper on which printing was performed has been removed from the discharge tray 101 is detected, and it is made impossible to perform the next job until detected that the paper on which printing was performed has been removed from the discharge tray 101.

On the other hand, when the print mode is selected in Step S6 (No in Step S6), a format in which information of other services and product-specific information is written is printed along with personal information, store information, and product information (Step S12). Thus, with a writing implement such as a ball pen, the customer can write in a response to information of other services and product-specific information on the paper on which the format was printed.

After entry of information on the paper by the customer is completed, the paper is captured by the image capturing unit 120, and the order form is output by printing, along with a copy of the order form for the customer (Step S13). The customer brings the order form that has been output to the POS register 200. Then, the payment procedure is carried out at the POS register 200 (Step S14).

After the payment procedure is completed, the POS register 200 requests that the digital multifunction printer 100 perform fax transmission. Thus, the digital multifunction printer 100 sends a facsimile of the order form filed and saved in the HD apparatus 180 via the telephone network 301 to the facsimile apparatus 400 of the corresponding service-providing company (Step S15). Here, after the payment procedure in the POS register 200 is completed, the data of the order form saved in the HD apparatus 180, after adding an electronic receipt stamp having payment information such as a store name and payment date to that data, is automatically sent by fax via the telephone network 301 to the facsimile apparatus 400 of the corresponding service-providing company. Then the flow of processing moves to Step S11, and processing is ended.

The present invention may be embodied in various other forms without departing from the spirit or essential characteristics thereof The embodiments disclosed in this application are to be considered in all respects as illustrative and not limiting. The scope of the invention is indicated by the appended claims rather than by the foregoing description, and all modifications or changes that come within the meaning and range of equivalency of the claims are intended to be embraced therein.

What is claimed is:

1. A product ordering apparatus having an operating unit capable of a human input operation and capable of displaying information, the product ordering apparatus being connected to a device of a service-providing company via a communications line, and connected to a settlement device for performing a payment procedure, and the product ordering apparatus being installed in a store that the service-providing company has entrusted with a service, the product ordering apparatus comprising:
a product selecting means that makes it possible to select and input information of the service entrusted from the service-providing company with the operating unit, and makes it possible to select and input product information in the selected service with the operating unit;
a form format determining means that, by product information being selected with the product selecting means, designates a corresponding service-providing company, and by designating the service-providing company, determines the format of an order form;
an information automatic input means that automatically inputs personal information of a customer that has been registered in advance and information of a store that has been registered in advance, along with product information that has been selected with the product selecting means, to data of the order form that has been determined with the form format determining means;
an order form automatic facsimile sending means that, after a payment procedure has been performed in the settlement device, due to a request from the settlement device, automatically sends by facsimile via the communications line, to the device of the service-providing company designated by the form format determining means, order form data in which personal information and store information as well as product information have been automatically input with the information automatic input means; and
a copy collective printing means that, after facsimile sending by the order form automatic facsimile sending means, when outputting a communications results report, prints together on paper the contents of the order form as a copy with the communications results report.

2. The product ordering apparatus according to claim 1, wherein the product selecting means displays a list with images such that service information of the service-providing company and product information thereof can be selected and input in the operating unit, and the list with images has a search function.

3. The product ordering apparatus according to claim 1,
wherein the product ordering apparatus is connected via a computer network to the settlement device, and can be connected via the computer network to a management server for managing information of the service-providing company as well as service information of the service-providing company and product information thereof, and furthermore, the product ordering apparatus is capable of reading a storage medium on which the information of the service-providing company as well as service information of the service-providing company and product information thereof have been stored in advance; and
the form format determining means is provided with a first determining means that automatically determines the format of the order form by designating a corresponding service-providing company via the computer network from the information of the service-providing company managed with the management server based on the product information selected with the product selecting means, and a second determining means that automatically determines the format of the order form by designating a corresponding service-providing company from the information of the service-providing company stored on the storage medium based on the product information selected with the product selecting means.

4. The product ordering apparatus according to claim 1,
wherein the product ordering apparatus is connected via a computer network to the settlement device, and can be connected via the computer network to an authentication server for authenticating personal information of a customer, and furthermore, the product ordering apparatus is capable of reading an IC card on which personal information of a customer has been stored in advance; and
the information automatic input means automatically inputs personal information of a customer by selecting either to read personal information that has been stored on the IC card from the IC card, or to request personal information of the authentication server from the authentication server via the computer network.

5. The product ordering apparatus according to claim 1,
wherein the order form data that has been automatically input with the information automatic input means is saved in a storage unit; and
the order form automatic facsimile sending means, after the payment procedure is completed in the settlement device, adds an electronic receipt stamp having payment information such as a store name and payment date to the order form data stored in the storage unit, and automatically sends the data by facsimile via the communications line to the device of the service-providing company designated with the form format determining means.

6. The product ordering apparatus according to claim 1, wherein the copy collective printing means has a security function to display a message that confirms whether or not there was a printing error after printing, such that a confirmation input operation is possible in the operating unit, and delete data used for the printing after the confirmation input operation has been performed.

7. The product ordering apparatus according to claim 1, comprising a discharge unit that discharges paper on which printing has been performed with the copy collective printing means,
wherein the copy collective printing means has a function to detect whether or not paper discharged to the discharge unit has been removed from the discharge unit, and until removal of the paper from the discharge unit has been detected, make it impossible to perform the next job, thus preventing forgetting to remove the paper from the discharge unit.

8. The product ordering apparatus according to claim 1, wherein after personal information, store information, and product information have been automatically input to an order form by the information automatic input means, a response to information of other services and product-specific information can be input from the operating unit, and it is possible to print a format in which personal information, store information, and product information, and information of other services and product-specific information, are written, and furthermore, it is possible to select between inputting the response from the operating unit, or printing the format.
